(19) United States
(12) Patent Application Publication
(10) Pub. No.: US 2006/0108334 A1
(43) Pub. Date: May 25, 2006

(54) Process for producing an electrical contact

(76) Inventors: Klaus Frietsch, Schramberg (DE); Matthias Mueller, Dietingen (DE); Karlheinz Storz, Hardt (DE); Richard Hettich, Schramberg (DE); Tobias Woelfle, Schramberg (DE)

Correspondence Address: NATH & ASSOCIATES, 112 South West Street, Alexandria, VA, 22314, US

(21) Appl. No.: 11/228,343

(22) Filed: Sep. 19, 2005

(30) Foreign Application Priority Data
Sep. 23, 2004 (EP) 04 022 661.5

(51) Int. Cl. B23K 26/34

(52) U.S. Cl. 219/121.64

(57) ABSTRACT

The invention relates to a process for producing an electrical contact, in which a coating that provides the contact is applied to a carrier by means of laser welding, such that a pulsed laser is employed as the coating material is introduced, in at least one laser pulse draw. The operating parameters are so selected that during the welding process the temperature in the welding area oscillates around the melting point, specifically in such a way that the melt alternately liquefies and again solidifies.

The invention relates to a process for producing an electrical contact in accordance with the preamble of claim 1.

Known from DE 101 57 320 A1 is a process for producing micro sliding contacts. The micro sliding contacts produced with this process serve to contact conductive tracks or surfaces in which there is frequently a relative motion between the micro sliding contacts and the conductive track or surface. In order to provide a reliable contact, the micro sliding contacts consist of a plurality of contact springs, which are positioned as close to each other as possible. The contact springs may, for example, be designed as spring tabs that are punched out of sheet metal strips. A denser arrangement of contact springs, i.e., a greater number of contact springs in the given surface area, can be obtained by using round wire for the contact springs.

In the known processes contact springs (supports) belonging to the micro sliding contacts are manufactured from a cost-effective metal with good elastic properties and good electrical conductivity. The high attrition strength and high resistance to corrosion which are necessary in contact springs are ensured by coating the support in the subsequent contact area by means of surface-layer welding employing an alloy that contains a precious metal.

In the surface-layer welding process a powder of the alloy containing the precious metal is melted onto the support using a pulsed laser ray. The energy introduced is large enough to provide a large melt, consisting of liquefied support material and liquefied coating material. A result of the known procedure is that mixing processes occur in the melt, particularly due to Marangoni flow, and this leads to a heavy intermixture of support material and coating material. This in turn means that when the layer thickness is small (which is desirable for reasons of cost), the degree of purity in the coating material on the contact area is not optimal, and this can have negative effects on attrition strength and resistance to corrosion.

The invention is based on the problem of specifying a process for producing a contact with which contacts of high quality can be manufactured at reasonable cost.

The invention solves this problem with a process exhibiting the features of claim 1.

Advantageous embodiments of the process are indicated in the secondary claims.

In the process according to the invention the temperature in the welding area is made to oscillate around the melting point of the support material and the coating material. Due to the intervals of time between the laser pulse peaks, the melt has sufficient time to lower the temperature below the melting temperature due to the conduction of heat into the support material and/or into the coating material already applied. As a result, the volume of the melt remains very small. In the process according to the invention the layer is constructed in cascade fashion. This means that for each laser pulse only a small upper layer of the already solidified material, along with the coating that has been added since the last liquefying event, is melted. Thus, as the coating increases in thickness there is a reduction in the intermixture of existing material and material that is newly melted, and thus a reduction in the proportion of support material in the coating. The result is a contact surface with an extremely high proportion (degree of purity) of coating material. The process according to the invention reduces the intermixture of the two materials as compared to known processes. Due to its high degree of purity, the coating provided by the invention's contact-producing process is extremely resistant to corrosion and to mechanical and abrasive wear. A feature that deserves special emphasis is the lastingly uniform electrical contact resistance of the coating created with the invention process. The coating is further distinguished by its high resistance to burn-up and material transfer.

In accordance with an advantageous embodiment of the invention it is provided that a laser pulse train comprises from 10 to about 20 laser pulses separated from each other in time. It is advantageous if these laser pulses have a roughly equal peak energy and a roughly equal energy density, as well as a pulse duration of roughly the same magnitude. As a rule, the coating process employs a plurality of laser pulse trains performed in succession. Here has it proved to be particularly advantageous if the laser pulse repetition rate lies in the range from about 5 kHz to 50 kHz, preferably between about 10 kHz and 20 kHz, and if the laser pulse train repetition rate within the laser pulse train lies between about 50 Hz and 500 Hz, preferably 50 Hz to 150 Hz. The upper limit for the laser pulse repetition rate lies in the area of 50 kHz. If this upper limit is exceeded the laser pulse pauses will be too small, with the result that the melt is unable to solidify and the melt volume increases in the course of the coating process. Intermixture consequently increases. The laser pulse repetition rate within the laser pulse train is determinant for the efficiency of the process. The process can be implemented with a laser pulse repetition rate of less than 10 KHz, but the coating process will accordingly unfold with greater slowness.

In order to provide a flatter coating of the support the support is moved in relation to the laser beam. The advancing speed will advantageously equal roughly 5 mm/s to 10 mm/s. The laser pulse train repetition rate is directly related to the relative speed. The greater the speed and/or the lower the laser pulse train repetition rate, the greater is the misalignment of the coated tracks on the support.

With the inventive process it is possible to create a desired coating contour (geometrically adaptive coating) on the support, for example, by modifying the relative speed between the laser beam and the support surface during the welding process. Different surface geometries can be created in this way. For example, by modifying the operating parameters in a regulated or controlled way during the surface-layer welding process it is possible to create a rounded or straight surface shape.

The invention is described below in greater on the basis of an exemplary embodiment depicted in the training. Shown are:

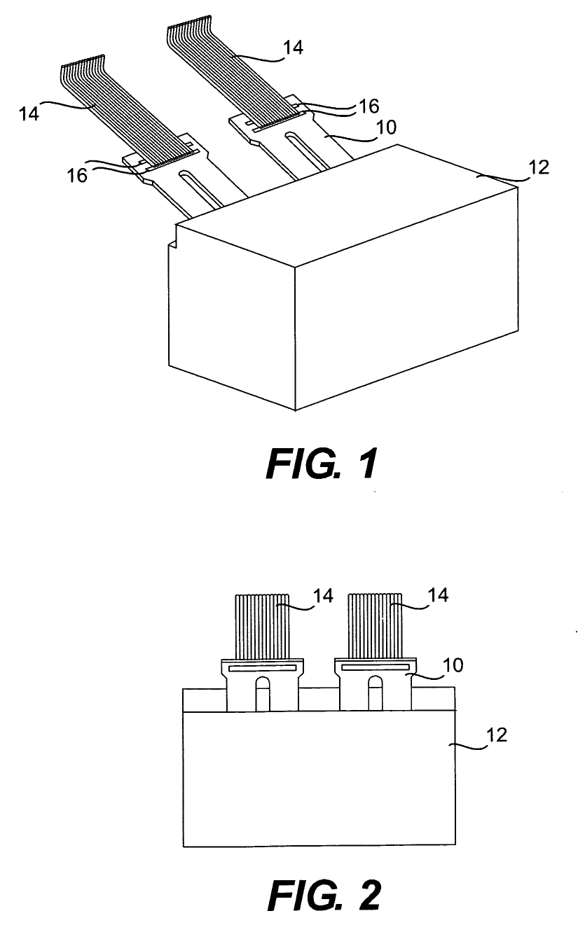

FIG. 1 an enlargement of a micro sliding contact, in a perspective view

FIG. 2 a top view of the micro sliding contact

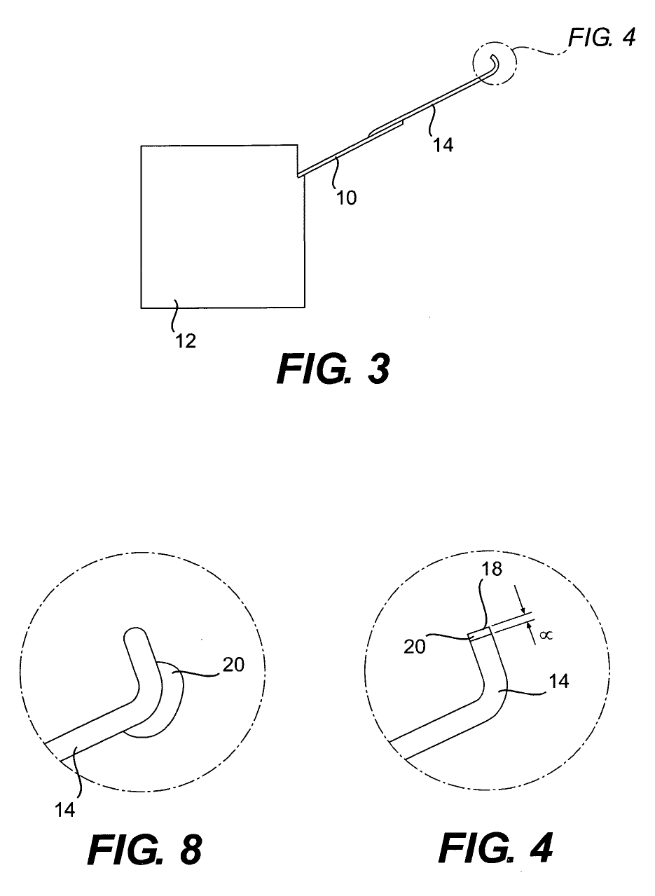

FIG. 3 a side view of the micro sliding contact

FIG. 4 an enlargement of detail A in FIG. 3, in accordance with the invention

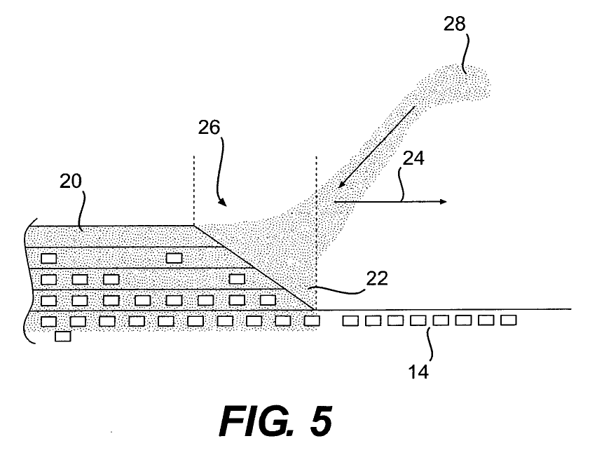

FIG. 5 a schematic depiction of the cascade-style coating

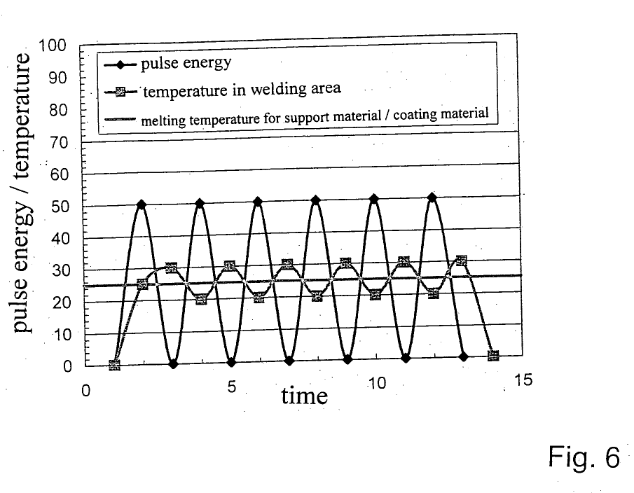

FIG. 6 a depiction of the pulse energy and the temperature over time during a pulse train with constant energy peaks

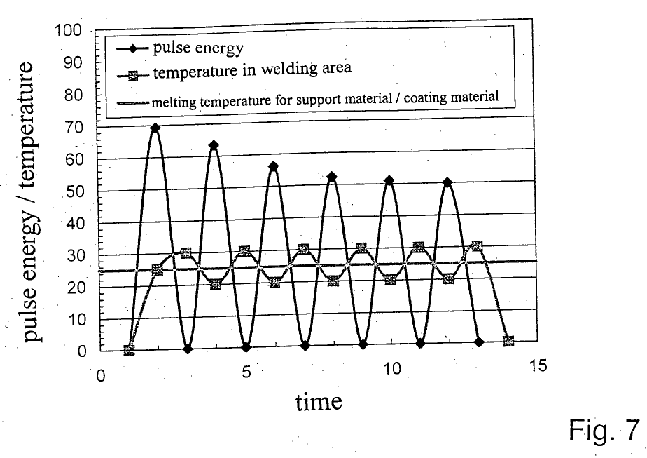

FIG. 7 a depiction of the pulse energy and the temperature over time during a pulse train with decreasing energy peaks

FIG. 8 an enlargement of detail A′ in FIG. 3, in accordance with the invention

FIGS. 1 to 3 show an example of a micro sliding contact as produced with the manufacturing or coating process according to the invention.

A U-shaped punched part 10 of sheet-metal, e.g., steel or a copper alloy, is inserted into a support block 12. Welded to the free side leg of the U-shaped punched part 10 are contact springs designed as supports 14; in the depicted example the contact springs take the form of round wires. At their back ends the supports 14 are welded to embossed ribs 16 belonging to the stamped part 10. The free ends 18 of the supports 14 are bent at a right angle. A coating 20 that provides a contact is applied to the free ends 18 of the supports 14; the coating 20 is applied according to the invention process.

The terminal face of the coating 20 rests on conductive tracks that are not depicted. The micro sliding contact is thus able to connect two conductive tracks over the coating 20, the supports 14, and the U-shaped punched part 10.

In the depicted exemplary embodiment a plurality of supports 14, e.g., fifteen round wires, each with a diameter of about 0.1 mm, are positioned side by side and touching each other. In this manner a large number of contact points can be arranged side by side over a relatively small width, e.g., 2 mm. It is evident that instead of round wire, supports 14 punched from the same sheet metal as the punched part 10 can be used as contact springs. When the supports 14 are punched, there remains a free space between them, so that the number of the supports 14 positioned side by side over a given width will be smaller in this design.

To ensure a lastingly constant electrical contact the coating's degree of purity is crucial. The less support material contained close to the surface of the coating 20 the more precisely will the desired alloy composition be reached and the fewer will be the signs of corrosion on the coating surface; the contact resistance will also be more constant over time.

To produce the coating 20, coating material, ideally the metal powder of an alloy containing a precious metal, is continuously applied to the surfaces of the support 14. The surface-layer welding will ideally be performed under protective gas and by means of a pulsed laser beam. Here it is decisive that the operating parameters are so selected that the temperature in the welding area 22 oscillates around the melting temperature, specifically in such a way that the melt alternately liquefies and solidifies. According to a preferred embodiment of the inventive process, the pulse energy of a laser pulse will lie between about 0.5 mJ and 5 mJ, particularly 1 mJ and 2 mJ. The effective laser beam cross-sectional area equals about 0.05 mm² for a preferred laser beam diameter of about 250 μm. For a pulse energy of, for example, 2 mJ there is thus a pulse energy density of about 40 mJ/mm² per laser pulse. The pulse duration is equal to roughly 0.01 ms to 0.1 ms, ideally 0.025 ms to 0.075 ms. The laser pulse repetition rate within a laser pulse train with about 10 to 20 laser pulses equals about 10,000 Hz. The mean power of a laser pulse roughly equals between 1,000 mW and 10,000 mW, preferably between 1,500 mW and 2,500 mW. Here the pulse peak power equals from about 50 W to 200 W, ideally 100 W to 150 W. The power density of a pulse lies in a range from about 1·10⁴ W/cm² to 1·10⁵ W/cm². Depending on the requirements, the thickness of the coating applied with a laser transit equals roughly 10 μm to 50 μm, and advantageously about 30 μm. In order to provide a flat coating it is desirable to execute the coating in several laser pulse trains; here roughly one laser pulse train is necessary to coat the surface of a round wire belonging to a micro sliding contact and about three laser pulse trains are necessary to coat a spring tab. The coating length of a laser pulse train is equal to about 0.1 mm. The laser pulse train repetition rate lies between 50 Hz and 500 Hz, ideally between 50 Hz and 150 Hz. In the described exemplary embodiment the laser beam diameter of about 250 μm is large compared to the diameter of an individual support (round wire), which equals 0.1 mm. In the described exemplary embodiment the relative speed between the laser beam and the support equals 5 mm/s. For supports which are wider than the diameter of the laser beam, the laser beam is positioned adjacent to an already coated track after one pulse train. In this manner it is possible to build up a flat coating in strip-like fashion. To increase the speed of the process it is also possible to employ a plurality of laser beams in serial and/or parallel fashion.

FIG. 6 depicts the relative laser pulse energy and the temperature in the melt zone as a function of time during a laser pulse train, with only six periodic individual laser pulses shown by way of example. The absolute dimensional specifications emerge from the value ranges indicated in the description and the claims. In the diagram it can be seen that, while laser pulses of the same energy follow in succession, the temperature in the welding area oscillates around the melting temperature of the carrier material and the coating material. For example, the diagram shows that the energy of the laser beam between two adjacent energy peaks drops to zero. This is not absolutely necessary; it suffices for there to be a phase of reduced laser energy between two peaks. The parameters must be selected in such a way that the melt has sufficient time to at least partially release the heat into the carrier material and, as a result, to solidify. Laser pulse trains are therefore conceivable in which longer pauses without laser activity, serving as cooling phases, are observed between the individual laser pulses. The depicted curve shape for the energy behavior of the laser pulses is selected only by way of example. Other curve shapes are equally conceivable, e.g., a highly rectangular, trapezoidal, sinusoidal, or triangular energy curve. At the end of the laser pulse train, the melt again cools down during time interval 3 and the coating grows completely solid.

FIG. 7 shows an alternative curve for the laser pulse energy as a function of time. The absolute dimensional specifications emerge from the value ranges indicated in the description and the claims. From the diagram it can be seen that the energy peaks of the successive laser pulses in a laser pulse train diminish logarithmically. In this way the heating of the carrier material that occurs over a laser pulse train is compensated for, or taken into account. In accordance with the invention, the temperature in the welding area also oscillates around the melting temperature of the carrier material and the coating material.

FIG. 5 schematically depicts the cascading structure of the coating 20. The arrow 24 symbolizes the relative speed between laser beam 26 and support 14; here the laser beam moves to right, in the direction of the arrow, relative to the support. In the depicted exemplary embodiment this relative speed equals 5 mm/s; the laser is in fixed position and the support 14 moves to the left below the laser. Coating material 28 is continuously fed to the welding zone 22. In this exemplary embodiment the coating material 28 is blown to the welding area 22 in the form of metal powder by means of a powder conveyor (not depicted). It is also conceivable to abrade the coating material from a supply body, for example, a wire of coating material, through laser bombardment and to thereby feed the material to the welding area (so-called laser droplet welding).

Because the melt alternately liquefies and hardens in the welding area, the entire volume of the melt remains very small. In FIG. 5 the laser beam 26 and the powder feed are moved to the right on the plane of projection, or, as the case may be, the support 14 is moved to the left. In the right portion of the welding area 22 the support material 14 and the coating material 28 located in this area are melted, as a result of which the two materials intermix and then solidify. In this process the laser beam 26 migrates further toward to the right on the plane of projection, to a minimal degree. With the following laser pulse only the upper layer of the just described portion of the melting area 22 again liquefies, along with the coating material that has been added in the interim. As a result the percentage portion of the coating material 28 in this area of the melt rises, and the intermixture with the molten support material drops very rapidly. The thicker the coating 20 becomes the higher is the degree of purity (portion of coating material) in the upper area of the coating 20. The degrees of purity achieved with the process according to the invention can only be provided by allowing the melt to alternately liquefy and harden. This procedure ensures that only the upper layer of the coating is melted, and the result is that the percentage portion of the newly added and continuously fed coating material increases as the coating thickness grows larger. Even for low coating thicknesses there is a high purity in the coating material of the surface area. Because of the very large surface/volume ratio involved, the metal powder provides a high specific absorption of the laser energy and is thereby heated up and melted. The “reflecting” base material of the support absorbs the laser energy only up to a depth that roughly equals the magnitude of the laser wavelength and is consequently heated on the surface only. Because of a thermal conduction process the heat is conducted into the support. As a result, an advantageous ratio of coating material to support material in the coating is obtained.

By varying the relative speed, it is possible to vary, e.g., the progression of the coating thickness and that of coating contour. If the coating is to be thicker at certain points on the support than at others, this special area can be traversed several times by the laser; or, as an alternative, the relative speed can be diminished in this area. It is likewise possible to influence the coating process by varying the density of the laser pulse energy, or by varying the length of the laser pulse, or by varying the repetition rate.

FIG. 8 shows an alternative embodiment of a micro sliding contact. In contrast to the embodiment shown in FIG. 4, here the coating 20 that provides the contact is not furnished on the free ends 18 of the support 14. Instead, the contact-providing coating 20 is furnished on the outer radius of the bent support 14. Using the coating 20 provided on its outer radius, the support 14 rests on conductive tracks, which are not depicted in the figure. The micro sliding contact can thus join two conductive tracks across the coating 20, the supports 14, and the U-shaped punched part 10.

### LIST OF REFERENCE NUMERALS

10 punched part
12 support block
14 support
16 embossed ribs
18 free end
20 coating
22 welding area
24 arrow (relative speed)
26 laser beam
28 coating material

1. A process for producing an electrical contact, in which a coating that provides the contact is applied to a carrier by means of laser welding, such that a pulsed laser is employed as the coating material is introduced, in at least one laser pulse draw
wherein
the operating parameters are such that during the welding process the temperature in the welding area oscillates around the melting point, specifically in such a way that the melt alternately liquefies and again solidifies.

2. A process for producing an electrical contact according to one of the preceding claims,
wherein
a laser pulse draw contains laser pulses, preferably about 10 to 20, that are separated from each other in time, ideally with an approximately equal peak energy and/or an approximately equal energy density and/or an approximately equal pulse length.

3. A process for producing an electrical contact according to claim 2,
wherein
the energy density of a laser pulse is from about 0.05 mJ/cm² to about 0.5 mJ/cm², preferably about 0.1 mJ/cm² to 0.2 mJ/cm².

4. A process for producing an electrical contact according to one of the preceding claims,
wherein
the laser pulse duration is from about 0.01 ms to about 0.1 ms, preferably about 0.025 ms to about 0.075 ms.

5. A process for producing an electrical contact according to one of the preceding claims,
wherein
the laser pulse repetition rate is about from 5 kHz to about 50 kHz, preferably about 10 kHz to 20 kHz.

6. A process for producing an electrical contact according to one of the preceding claims,
wherein
the laser pulse peak power density is from about 1·10⁴ W/cm² to 1·10⁵ W/cm².

7. A process for producing an electrical contact according to one of the preceding claims,
wherein
the effective laser beam diameter is from about 0.1 mm to about 1 mm, preferably about 0.2 mm to about 0.5 mm.

8. A process for producing an electrical contact according to one of the preceding claims,
wherein
the laser beam cross-sectional area is from about 0.03 mm² to about 3.15 mm², preferably about 0.28 mm² to about 0.79 mm².

9. A process for producing an electrical contact according to one of the preceding claims,
wherein
a relative motion between the laser and the support is provided, such that the relative speed between the laser and the support is from about 1 mm/s to 20 mm/s, preferably about 5 mm/s to 10 mm/s.

10. A process for producing an electrical contact according to one of the preceding claims,
wherein
a plurality of laser pulse draws are performed in order to coat a support, preferably with a laser pulse draw repetition rate of from roughly 50 Hz to roughly 500 Hz, ideally from about 50 Hz to about 150 Hz.

11. A process for producing an electrical contact according to one of the preceding claims,
wherein
the coating thickness applied with one laser pulse draw is from about 5 μm to about 100 μm, preferably about 30 μm.

12. A process for producing an electrical contact according to one of the preceding claims,
wherein
the laser beam is newly positioned after each pulse draw, preferably adjacent to an already coated track, in order to produce a flat coating.

13. A process for producing an electrical contact according to one of the preceding claims,
wherein
the energy peak, or peaks, of the first laser pulse of a laser pulse draw are greater than the remaining energy peaks of the laser pulse draw.

14. A process for producing an electrical contact according to claim 13,
wherein
the energy peaks of the successive laser pulses of a laser pulse draw will diminish, preferably in linear or logarithmic fashion.

15. A process for producing an electrical contact according to one of the preceding claims,
wherein
the temperature of the melt is monitored, particularly with an infrared camera, and the laser beam activity directed at the melt is controlled as a function of the temperature of the melt, preferably in a manner such that when the temperature of the melt drops below the melting temperature, the melt is subjected to at least one laser pulse.

16. A process for producing an electrical contact according to one of the preceding claims,
wherein
the carrier (14) is coated with coating material (28) in geometrically adaptive fashion, specifically by modifying at least one operating parameter during the welding procedure, preferably as a function of the temperature of the support (14), and/or as a function of the temperature of the coating (20), and/or as a function of the temperature of the melt, and/or as a function of the coating thickness.

17. A process for producing an electrical contact according to one of the preceding claims,
wherein
the coating thickness is varied by allowing the laser beam to make a plurality of passes over the same point, chiefly a plurality of passes over an already coated track.

18. A process for producing an electrical contact according to one of the preceding claims,
wherein
the contacts produced are micro sliding contacts with a plurality of contact springs provided with a coating.

19. A process for producing an electrical contact according to one of the preceding claims,
wherein
the coating material (28) consists of an alloy that contains at least one precious metal.

20. A process for producing an electrical contact according to one of the preceding claims,
wherein
the alloy for the coating contains one or more of the metals platinum, palladium, gold, and silver.

21. A process for producing an electrical contact according to one of the preceding claims,
wherein
the alloy with at least one precious metal contains copper.

22. A process for producing an electrical contact according to one of the preceding claims,
wherein
the wave length of the laser light for the support material containing copper is about 532 nm.

23. A process for producing an electrical contact according to one of the preceding claims,
wherein
the wavelength of the laser light for support material containing iron is about 1064 nm.

24. A process for producing an electrical contact according to one of the preceding claims,
wherein
the coating material is fed continuously.

25. A process for producing an electrical contact according to one of the preceding claims,
wherein
the coating material is fed as a powder, ideally blown by a powder conveyor using protective gas (e.g., Ar, N₂, He).

26. A process for producing an electrical contact according to one of the preceding claims,
wherein
the coating material is fed from a reserve body, specifically coating material in the form of a wire, that is melted by laser bombardment and thereby fed into the welding area.
